(19) United States
(12) Patent Application Publication
(10) Pub. No.: US 2024/0076213 A1
(43) Pub. Date: Mar. 7, 2024

(54) METHOD AND SYSTEM FOR CAPILLARY FLOW IN MICROPOROUS ALUMINUM NITRIDE FOR NON-THERMAL SOLAR DESALINATION

(71) Applicant: The Regents of the University of California, Oakland, CA (US)

(72) Inventors: Luat T. VUONG, Riverside, CA (US); James Li-Guo LEUNG, El Monte, CA (US); Navindra D. SINGH, Riverside, CA (US)

(73) Assignee: The Regents of the University of California, Oakland, CA (US)

(21) Appl. No.: 18/462,712

(22) Filed: Sep. 7, 2023

Related U.S. Application Data
(60) Provisional application No. 63/404,333, filed on Sep. 7, 2022.

(51) Int. Cl. C02F 1/52; F28D 15/04

(52) U.S. Cl. CPC C02F 1/5236; F28D 15/04; C02F 2103/08

(57) ABSTRACT

A microporous wick and a method for non-thermal solar desalination is disclosed, which includes placing a capillary wick in a brine containing sodium chloride (NaCl), the capillary wick comprising a plurality of bonded aluminum nitride (Al—N) microparticles and illuminating the capillary wick with a light source.

### CROSS-REFERENCES TO RELATED APPLICATIONS

This application claims priority to U.S. Provisional Patent Application No. 63/404,333 filed on Sep. 7, 2022, the entire content of which is incorporated herein by reference.

### TECHNICAL FIELD

The present disclosure relates to a method and system for capillary flow in microporous aluminum nitride for non-thermal solar desalination.

### BACKGROUND

Solar-thermal desalination processes involve the conversion of absorbed light into heat, which evaporates and separates water from a saltwater reservoir. These processes cannot achieve 100 percent efficiency though, as inefficiency arises from any heat leakage from the solar desalinating mechanism to its surroundings such as the bulk reservoir, where water's high specific heat capacity allows the bulk reservoir to maintain a lower temperature. Heat leakage occurs from the entropy-driven transfer processes such as: thermal diffusion, photon thermalization of black-body emission, or the heat released when vapor condensation. Additionally, there are inevitable losses due to conduction and convection from the water in contact with the substrate and/or reservoir. Thermal radiation of the captured heat must also be mitigated. This thermal emittance is significant with solar thermal concentration designs since radiative heat losses scale with the fourth power of the surface temperature.

These inevitable leakages of the already-captured heat are not the only unavoidable challenges to contend with in the thermal desalination paradigm. The water-to-steam conversion is an energy-intensive process simply due to the high latent heat of vaporization of water. This means more energy goes into changing the phase of the liquid water.

It is important to mention that in spite of the challenges, researchers have achieved ways of mitigating the inefficiency by recycling the energy from the condensation process and by designing the spectral properties of windows and surfaces. Multistage processes reduce leakage with infrared-reflecting windows and surfaces that recapture the heat released from the vapor condensing have been demonstrated. This process is referred to as enthalpy recycling.

### SUMMARY

In accordance with an embodiment, a microporous wick is disclosed, the microporous wick including a plurality of bonded aluminum nitride particles.

In accordance with another embodiment, the aluminum nitride particles are microparticles. For example, the aluminum nitride particles can have a diameter of approximately 5 μm to 25 μm, and more preferably about 10 μm. The plurality of bonded aluminum nitride particles forms a plurality of channels, the plurality of channels having approximately a same diameter as the plurality of aluminum nitride particles themselves. For example, the plurality of bonded aluminum nitride particles forms a plurality of capillaries.

In accordance with an embodiment, a method for non-thermal solar desalination or debrining is disclosed, the method includes placing a capillary wick in a brine containing sodium chloride (NaCl), the capillary wick comprising a plurality of bonded aluminum nitride (Al—N) microparticles; and illuminating the capillary wick with a light source.

In accordance with an embodiment, the method includes illuminating the capillary wick with the light source having a wavelength of 190 nanometers to 750 nanometers. For example, the method can include illuminating the capillary with the light source having a wavelength of 380 nanometers to 495 nanometers. In accordance with an embodiment, the method can include illuminating the capillary wick with the light source having a wavelength of 450 nanometers to 495 nanometers.

In accordance with an embodiment, the method can include illuminating the capillary wick with the light source having a wavelength of wavelength of 380 nanometers to 750 nanometers at 35 mW·cm⁻² to 100 mW·cm⁻².

In accordance with an embodiment, the brine is sea water. In another embodiment, the brine is waste-water brine or industrial effluent. In a further embodiment, the brine is a brine carrying valuable minerals to be harvested.

In accordance with an embodiment, the method can include directing the light source towards the capillary wick at a horizontal orientation. The method can also include reducing a relative humidity of a surrounding of the capillary wick and the brine to increase evaporation rate.

In accordance with an embodiment, the method includes separating the sodium chloride from the water in the brine by crystallizing the sodium chloride and evaporating the water as a liquid.

In accordance with another embodiment, the brine is from an industrial source, and the method further includes obtaining a zero liquid discharge in the separation of the sodium chloride from the water in the brine and the evaporation of the water as a liquid.

In accordance with an embodiment, a method for evaporative cooling is disclosed, which includes blowing a source of air through a capillary wick. Radiative cooling is achieved additionally when the capillary wick comprising a plurality of bonded aluminum nitride microparticles is used outdoors.

### BRIEF DESCRIPTION OF THE DRAWINGS

FIGS. 1a-1c include FIG. 1a, which is a depiction of the expected processes of both salt crystallization and water evaporation as water is wicked up into the aluminum nitride micropores; FIG. 1B is an aluminum nitride wick pre-trial; and FIG. 1c is an aluminum nitride wick post-trial with 300000 ppm salinity water

FIGS. 2a-2d include FIG. 2a is a pre-trial at 400 μm relative size; FIG. 2b is pre-trial at 50 μm relative size; FIG. 2c is an FTIR comparison of Al—N before and after deposition process on wick; and FIG. 2d is an XRD analysis of Al—N before and after deposition process on wick.

FIG. 3 is a comparison of the different calculated mass rates that each trial achieved under different conditions.

FIG. 4 is a comparison of the required energy to thermally boil an amount of liquid for varying starting relative humidities vs. how much light energy was absorbed by the system, with Al—N having approximately 0.15 reflectance and 0.75 transmittance, its absorbance would be at 0.1, and it is assumed 10% of the light is absorbed by the wick.

FIG. 5 is a depiction of the effect that increasing starting relative humidity (and consequently increased overall humidity over the trial) leads to lower evaporation.

FIGS. 6a and 6b include FIG. 6a, which is a chart of the evaporation rates done with different starting relative humidities, and FIG. 6b, which is a chart of the change in relative humidity over the course of the same trials. The charts seem to follow the inverse trend of each other.

FIGS. 7a-7f is a comparison of the different salt crystallization patterns across different trials at different humidities, which include FIG. 7a, no light with starting RH 56%;

FIG. 7b, light with starting RH 55%; FIG. 7c, light with starting RH 39%, FIG. 7d, light with starting RH 39%; FIG. 7e, light with starting RH 36%, and FIG. 7f, light with starting RH 26%.

FIGS. 8a and 8b are schematics of interfacial nucleation with light, in which FIG. 8a is an aluminum nitride pore, where water rises to the surface of the wick via capillary action and forms both a meniscus at the pore ex-posed to the environment as well as a film of water at the exposed surfaces, and FIG. 8b illustrates that light illumination leads to water evaporation at the liquid-vapor interface, where salt crystallizes onto the aluminum nitride wick at the edges of the pores.

FIGS. 9a-9d illustrate extrapolation of specific heat (FIG. 9a), latent heat of vaporization (FIG. 9b); mass change as a function of time for 3 salinities (FIG. 9c); and comparison of the effective thermal energy and the actual energy from light needed for evaporation (FIG. 9d).

FIG. 10 illustrates evaporation rates versus light at varying salinity.

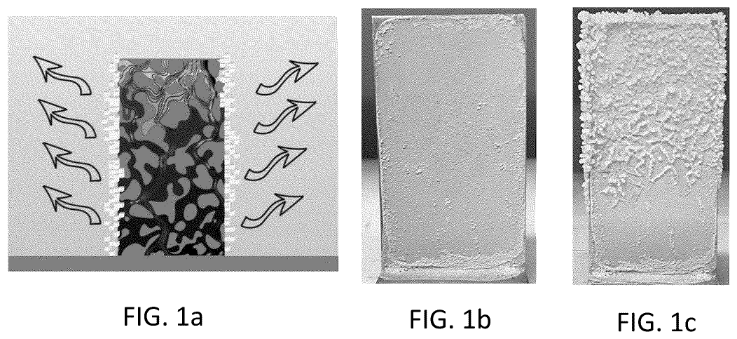

### DETAILED DESCRIPTION

Set forth below with reference to the accompanying drawings is a detailed description of embodiments of a system and method and system for capillary flow in microporous aluminum nitride for non-thermal solar desalination. Note that since embodiments described below are preferred specific examples of the present disclosure, although various technically preferable limitations are given, the scope of the present disclosure is not limited to the embodiments unless otherwise specified in the following descriptions.

Enhanced knowledge of the interfacial optical, thermal, and radiative processes offers new solar desalination, debrining, light-enhanced evaporation, and zero-liquid discharge technologies. Solar-thermal desalination involves four important subprocesses, which are described: (i) charge transfer between the aluminum nitride and brine: aluminum nitride is used because its bandgap matches the binding energy between salt and water. (ii) minimal thermal conversion and transport: light absorbed by aluminum nitride breaks salt-water bonds without significant increases in average kinetic energy of the sale and water molecules; (iii) ion transport and salt nucleation: salt is drawn into the capillary wick and nucleates on the wick; (iv) vapor manipulation and water yield: design of the airflow through the wicking material. In contrast to prior, interfacial solar desalination systems, the proposed invention does not require high temperatures, which lead to radiative losses. Higher efficiencies can be achieved by increasing the solar absorption in the aluminum nitride and reducing the heat loss through conduction, convection, and radiation.

Other keys to mitigating thermal leakage involve reducing the area of the water path to reduce the heat loss through conduction, increasing the distance of the heating location from the reservoir, or localizing the heating of the water into small packets at a time. While not seeking to utilize heat, the principles of mitigating potential energy loss and also packetizing the water will be utilized in the system and method disclosed herein.

Polycrystalline Aluminum Nitride (Al—N) is a white, hydrophilic, thermally conducting, high-band-gap ceramic with low visible-light-spectrum emissivity. Aluminum Nitride being hydrophilic makes it capable of utilizing capillary action, which means it can be used as a material for wicking. In accordance with an embodiment, a method and system for non-solar desalination is disclosed based on the light-induced evaporation of saltwater through a capillary wick composed of drop-cast, loosely bonded Al—N microparticles. With, for example, a light source having a wavelength of 190 nanometer (nm) to 750 nanometer (nm), for example, a 190 nm to 495 nm, and for example, a 405 nm, water evaporation rates can be increased to levels above equivalent-energy thermal evaporation rates.

In accordance with an embodiment, with a 405-nm LED light illuminating the wick, water evaporation rates are increased to levels above equivalent-energy thermal evaporation rates. (Note that in experimental results, the effect of light was carefully isolated by properly referencing experiments without light. In many reported papers today, this reference is not performed so that the reported effect refers to a combination of regular evaporation in addition to light). The effect of humidity and crystallization on the trials was checked and showed how both act as inevitable inhibitors to the evaporation process. Oscillations in the evaporation rate occur as well, caused by a dominance in either crystallization or dissolution in the pores and observations point to the potential of a novel solar non-thermal desalination approach.

Capillary Action and Imbibition

Models that consider gradient distributions of liquid in the wick aid analysis of the evaporation and are considered. The Hertz-Knudsen (H-K) equation relates the evaporated mass flux from the surface of a liquid in relation to the pressure differences that develop in the liquid during evaporation. However, tests, for example, have suggested that something more guides evaporation other than the pressure of the liquid and equilibrium pressure. Evaporation via capillary methods further drives this point home, as such methods seem to bypass predicted values as calculated by the H-K equation.

Capillary action transports liquids without mechanical input. Because it typically happens through small channels, the process funnels the liquid into smaller units of water at a time, thus enabling more exposure of the liquid to air and thus more evaporation of the water. Capillary action only occurs when the adhesive forces between a liquid and its surroundings are greater than the cohesive forces within itself, thus the wicking material must be more hydrophilic than water. This allows a liquid to pull itself up through a narrow channel without the aid of external forces. In a porous material like a paper towel, each pore acts as a narrow channel in which capillary action takes effect; this is what's responsible for paper towels' ability to pick up water in a process called imbibition. The effect of imbibition then essentially packetizes the bulk water, increasing the overall surface area per unit volume of the liquid and consequently making vaporization occur more readily.

Liquid molecules moving on or between interfaces experience larger free energy gradients than those escaping from the middle of bulk liquid or pore channels. Liquid near the solid surface tends to form into monolayers, which leads to a high potential energy in the liquid. There is a smaller energy barrier between the liquid and vapor phases of water where the liquid comes into contact with the walls of the solid. Thus, evaporation of the liquid increases near the interfaces.

The inspiration for the aluminum nitride wick stems from the studying of plants, particularly mangroves. Mangroves grow in intertidal zones, where the sea meets rivers and other similar fresh water sources. This means they must be able to filter the salt water they absorb in order to live, which is done via forcing the salt water through a semipermeable membrane and then forcing the remaining salt out of pores in their leaves. The leaves are also the location where evaporation occurs; this evaporation is also key, as it generates negative pressure zones in the plant's capillaries which aids the plant's filtration mechanism.

In accordance with an embodiment, a method and system are disclosed that uses aluminum nitride microparticles sintered together to act as the porous material in which capillary action can be utilized, the packed particles become analogous to a porous medium. Laser and spark plasma sintering are considered processes that will readily enable robust realization of the capillary wick. In accordance with an embodiment, the spacing between the packed microparticles should not be so large that they do not form capillaries, but not so small that they themselves impede the movement of the water molecules. Ideal fill fractions with aluminum nitride may vary from 30%-60%. While the method and system leverages capillary action and evaporation driven water dynamics, the system and method will not be using a filter for salt capture. Instead, a phenomenon called salt creep will be utilized for further separation of the salt and water.

Salt Crystallization and Salt Creep

When a solute dissolves in a solvent, the solvent molecules surround the solute molecules and pull them apart. In this case, sodium chloride molecules are torn into sodium cations and chloride anions by the strong polar properties of the solvent, water. Once these ions are formed in the solution, they soon “coordinate” the water into forming a network of bonds in the solvent-solute that act like a mesh that holds the ions within it. While solvents have solutes dissolved into them, a number of their physical and chemical properties are affected.

The location of salt crystallization can also depend on the ratio of water evaporation from the pores to the supply of water to the pores from capillary action. Crystallization will occur deeper in the pores when the evaporation rate exceeds the water supply rate, a result that as mentioned previously should be avoided in order to prevent salting out. This crystallization begins in zones of supersaturation, located around the vapor-liquid interface of the meniscus and depositing on the liquid-solid interface.

Salt creep also occurs on the wick as the evaporation proceeds. The salt crystallizes wherever the liquid/air interface is, namely the meniscus formed by the liquid in the pores. This does cause the salt to crystallize both inside and outside the pores of the wick though primarily on the outside surfaces; whenever the meniscus does drop deeper into the pores, salt will start nucleating inside the channels. This experimental observation indicates that there may be an optimal illumination intensity given a pore wick size.

The salt that crystallizes onto the wick either helps or hinder the evaporation process depending on the location of crystallization. Salt in a solution serves to decrease the vapor pressure of the solution, because the mere presence of the salt solute decreases the amount of the water solvent spots on the surface of the liquid to evaporate. The salt that crystallizes onto/inside the pores themselves does clog it and thus hinders the fluid transport in the capillary. On the other hand, salt that crystallizes on the outer edges of the porous material sample leads to growth of larger crystals, because the new salt crystals serve as new areas for the salt solution to nucleate. The movement of the salt solution does get transported to the crystallization edge as well, serving as another platform for liquid water transfer.

The method and systems as disclosed herein focus on light-induced potentials that combine with capillary-based desalination processes and interfacial charge transfer that bypass the heat-producing mechanisms that are typically associated with solar desalination. The method and systems disclosed herein also utilize capillary action, water packetizing, radiative cooling of the wick material, reduction of free-energy barrier from interfacing of solid-liquid-vapor, and salt crystallization creep.

### Experimental Section

Wick Fabrication

Porous, aluminum nitride (Al—N) wicking material were fabricated via repeated drop-casting of a solution of aluminum nitride microparticles and deionized water onto a heated Alloy-3003 aluminum substrate. The aluminum nitride particles are 10 microns large at a 99% consistency. The slurry solution consists of approximately 0.25 g of Al—N to approximately 30 mL of water and, as Al—N is not water soluble, requires constant stirring, for example, by hand.

The substrate gets heated on a hot plate, for example, up to 100° C. initially; any higher temperature can trigger the Leidenfrost effect and therefore makes the solution incapable of depositing onto the aluminum substrate. Then the slurry solution is swirled thoroughly to generate a rough emulsion, as Al—N and water do not mix well, before a layer is then applied on to the aluminum by “dragging” the solution across the surface to create a film. Once a layer is deposited, the heat is brought up to, for example, 200° C. to dry and then brought back down, for example, to 100° C. again to avoid the Leidenfrost effect. These steps are repeated until no more slurry solution is available.

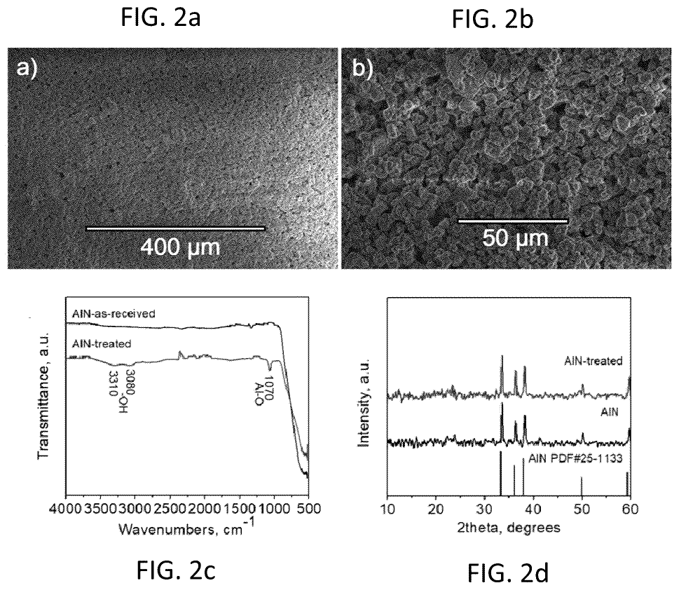

After the fabrication of a sample, the wicking layer was brought to a TESCAN VEGA3 SEM machine to capture SEM images, depicting the microparticles to check for any phase changes. FIGS. 2a and 2b show how the Al—N particles are loosely bonded to each other, with multiple pores/channels of roughly the same diameter as the particles themselves. Then a sample portion of the wicking layer was taken along with the original Al—N microparticles to be analyzed with Fourier-Transform Infrared (FTIR) and X-Ray Diffraction (XRD) Spectroscopy machines. FIGS. 2c and 2d are the FTIR and XRD analysis showing any changes the Al—N might have undergone during the deposition process. The FTIR shows that the treated sample contains slight amounts of —OH groups, indicating the formation of Al(OH)3. The treated sample has some quantities of nano-sheet structures on the surface, in this case it is the typical structure of Al(OH)3 which the presence of is previously confirmed in the FTIR. The XRD shows that the treated sample is still primarily Al—N, and no fundamental changes occurred during the fabrication process.

### Experimental Setup

Experiments were done in a sealed, acrylic glovebox that has dimensions of 24×36×18 inches. A tarp covers the box to both protect from LED glare and also minimize light interference. Humidity levels were brought down to initial conditions using silicone-gel desiccants; desiccant was taken out once trials started, so humidity inside the box was not controlled throughout the trials. The optical setup starts from a 405 nm LED that is focused down with a lens into an aperture. This controls the amount of light going into a collimating lens that re-columnizes the light before it goes into a cylindrical lens, which changes the shape of the beam into an elliptical shape. The cylindrical lens is held on an octagonal holder that was designed and 3D printed, which allows the orientation of the light to be changed into either vertical or horizontal orientations. The beam has an approximate area of 1 cm². Intensities of approximately 150 mW/cm² were achieved that reach the wick from the setup. Compared to the average solar illumination on the Earth's surface of 100 mW/cm², that means that the system and method uses about 1.5 times the average solar illumination.

In accordance with an embodiment, a 405 nm LED light was shined onto the porous wick made of drop-coated 10 μm Aluminum Nitride particles. Mass measurements were taken on an Ohaus™ Explorer™ micro-balance, at intervals of every minute for a total of 900 minutes. Relative humidity, temperature, and pressure were measured on a Fisherbrand™ Traceable™ Excursion-Trac™ USB Datalogging barometer, where data points were also taken every minute. The incident light power was measured using a Thorlabs™ S310C—Thermal Power Sensor Head. The trials used a salt solution of salinity 300,000 ppm in order to mimic waste brine salinity. Mass rate data was taken by taking the initial mass and subtracting subsequent weight data minute by minute.

Results

The mass rate data, henceforth called evaporation rate, was processed in Python using the sav.gol filter function from scipy library, with a window length of 21 points, a polynomial order of 2, and in ‘interp’ mode, in order to smooth out noise. The evaporation rate comparison between the first vertical and horizontal orientation trials showed a similar magnitude of performance, with no discernible differences that could not be attributed to noise. The second trials of each had differing humidities. This led to the rest of the experiments being done with horizontally oriented light.

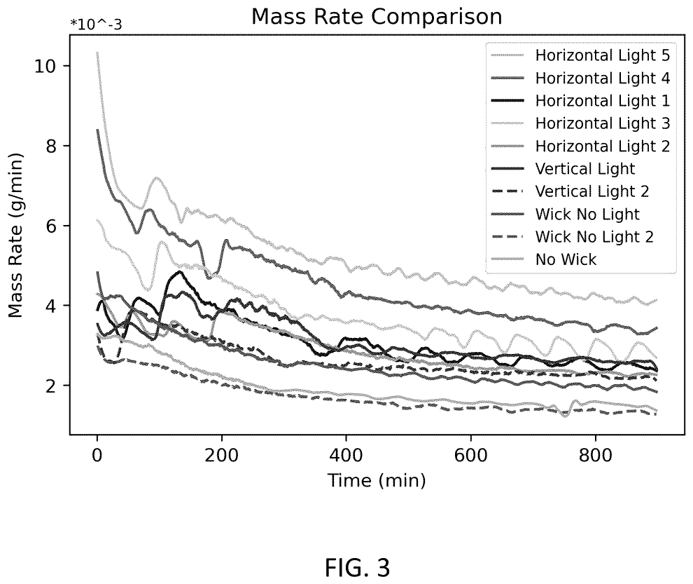

The evaporation rate without wick is lower than all trials with wick, and further increases with the presence of light, as seen in FIG. 3. This means the aluminum nitride wick effectively shows an ability to increase the evaporation rate of water under illumination. Using an illumination of 150 mW over 1 cm² area, about 1.5 suns, rates achieved included: 1.57, 1.86, 2.25, 2.70, and 3.13 kg m⁻² hr⁻¹ using the horizontal orientation of light at decreasing levels of starting relative humidity.

The evaporation flux at 55% starting relative humidity. 1.57 kg m⁻² hr⁻¹ is within the same magnitude as other evaporation experiments that mainly focus on solar-thermal conversions and black surfaces. For example, developed doped (N) and undoped (G) porous graphene sheets grown at different temperatures (800° C., 950° C.) in 2015, under an intensity of about 1 sun, were capable of 1.5 kg m⁻² hr⁻¹ for N950, 1.32 kg m⁻² hr⁻¹ for G950, 1.14 kg m⁻² hr⁻¹ for N800, and 1.04 kg m⁻² hr⁻¹ for G800. In 2020, Singh et al. utilized laser treatments to convert an aluminum sheet into a SWSA (super-wicking super-light-absorbing) surface, a black panel with microchannels that achieved evaporation rates under an intensity of 1 sun of kg m⁻² hr⁻¹ and 0.5 kg m⁻² hr⁻¹ for double-sided and single-sided sheets respectively.

Heat Vs. Light Effects

Calculations for the amount of light energy absorbed by the system were run as well as the amount of thermal energy required to boil the same amount of water that the system evaporated. This was to check if the observed evaporation rates are indeed photomechanical, non-thermal dynamics and not thermal-based on light shining.

Due to the wicking Al—N layer consisting of roughly drop-casted circular microparticles, an average incident angle of 0 degrees was estimated. The reflection and transmission coefficient for the Al—N films was calculated using Fresnel's equations, this average incident angle, and refractive index values found by Joo et al, Khoshman et al and Alsaad et al. The reflection and transmission come out to be at approximately 0.15 and 0.75. With Al—N having approximately 0.15 reflectance and 0.75 transmittance, its absorbance would be at 0.1.

The thermal energy was calculated that would be used to evaporate each amount of water to be and compared it to the expected amount of light energy absorbed by the wick system. First, the boiling point elevation was found using the boiling point elevation equation ΔT=Kib.

Equations:

ΔT_{Boil}=Kib (1)

Q=Cₛₒₗᵤₜᵢₒₙ(m_{water}+mₛₐₗₜ)(T₀+ΔT_{Boil}−Tᵢ) (2)

Equation (1) gives the boiling point temperature elevation of water when a solute is dissolved into it. K is the Ebullioscopic constant (units K kg/mol) which relates molality to boiling point elevation, i is the van't Hoff factor which gives the number of particles the solute splits into when dissolved, and b is the molality of the solution.

Equation (2) was used to calculate how much energy it would have taken a thermal boiler to evaporate the same amount of water as the solar wick as disclosed. An approximate value for the specific heat of the solution, Cₛₒₗᵤₜᵢₒₙ, was found via extrapolation of the data found in Randall et al's experiments. The same was done with data from Sharqawy et al's data for the latent heat of vaporization of the solution.

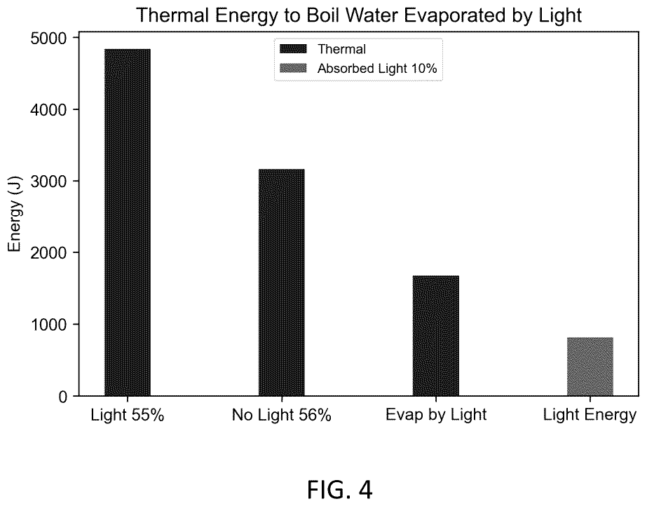

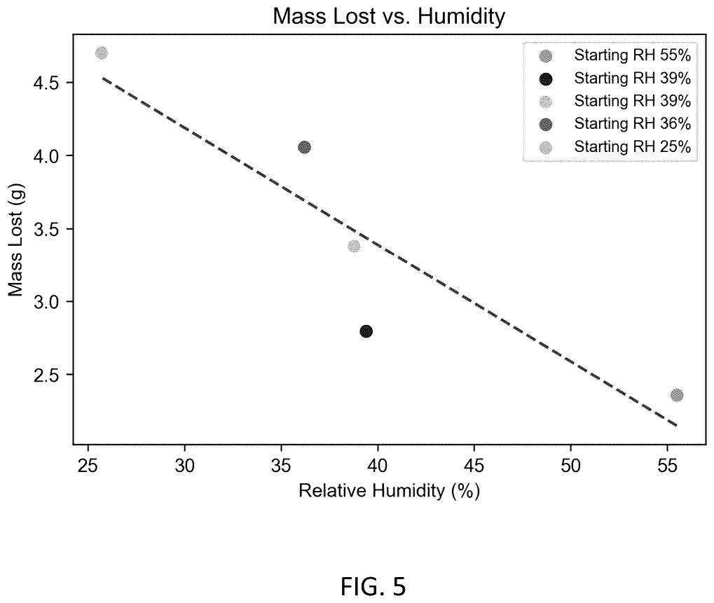

The energy comparison between an estimated thermal boil and solar desalination of the wick system in FIG. 4 shows that the method as disclosed does not primarily use thermal methods to evaporate water. Experiments that compare the spectral components of light with different evaporation and salt nucleation rates indicate that higher rates are achieved with light that is more readily absorbed by aluminum nitride. When light is not absorbed by aluminum nitride by other parts of the system (reservoir vessel, substrate, enclosing materials), then heating occurs. Heating the system is unavoidable while the system is under broadband illumination, but this comparison serves to separate the disclosed desalination method from other projects, which utilize solar-to-thermal converters. Note that with the disclosed invention the material is white, whereas most solar desalination systems that are based on thermal effects utilize black materials.

Humidity Effect

Relative humidity (RH) is defined as the amount of water vapor in the air versus the amount of water vapor the air can hold at saturation, but it can also be described as the ratio of water vapor pressure to the water vapor saturation pressure.

An idea for this change in vapor pressure can be obtained from the equation for vapor pressure of solution from Raoult's Law: Pₛₒₗᵥₑₙₜ=XₛₒₗᵥₑₙₜPₛₒₗᵥₑₙₜ where Pₛₒₗᵥₑₙₜ is the vapor pressure of the solvent above the solution, Xₛₒₗᵥₑₙₜ is the mole fraction of the solvent in the solution, and Pₛₒₗᵥₑₙₜ is the vapor pressure of the pure solvent.

The steady overall decline in the entire trial's evaporation across different trials coincides with increase in humidity inside the experimental system. Increases in humidity raise the free energy barrier for water to evaporate until it reaches an equilibrium.

The RH of the volume increases over time as the wick evaporates water. The humidity increase over time follows a logarithmic growth, while the evaporation rate trend does the inverse, showing that an increase in RH in the system coincides with a decrease in the evaporation rate. Rising humidity increases the vapor pressure required for water to evaporate, in other words, it increases the energy barrier in the system for evaporation, which makes it more difficult for water to evaporate.

Hamdan et al. checked for weight loss percentage, so a difference between 22% RH and 85% RH (+63%) led to a difference of ˜8% weight loss. In the experiments as disclosed, the % RH change is from 36% RH to 55% RH (+19%), leading to a difference of weight loss percentage equal to 13.5% and 11.1% respectively, a difference of ˜2.4% weight loss. This leads to a ratio of 3.31 and 3.33 between % RH and weight loss difference, which may indicate a linearly proportional relationship between humidity and evaporation performance at these levels of humidity.

This humidity-controlled effect can be assumed to be negligible in an open environment, even though it still occurs, because the evaporated water will diffuse away from the system due to exposure to the environment; the wick was placed in a closed system, isolated from the environment in order to mitigate the effect of potential variables such as wind/air flow, and temperature changes in order to study this effect. Ideal designs for the wick can be maximized and designed for air flow around the wick.

Salt Crystallization and Salt Creep Effect

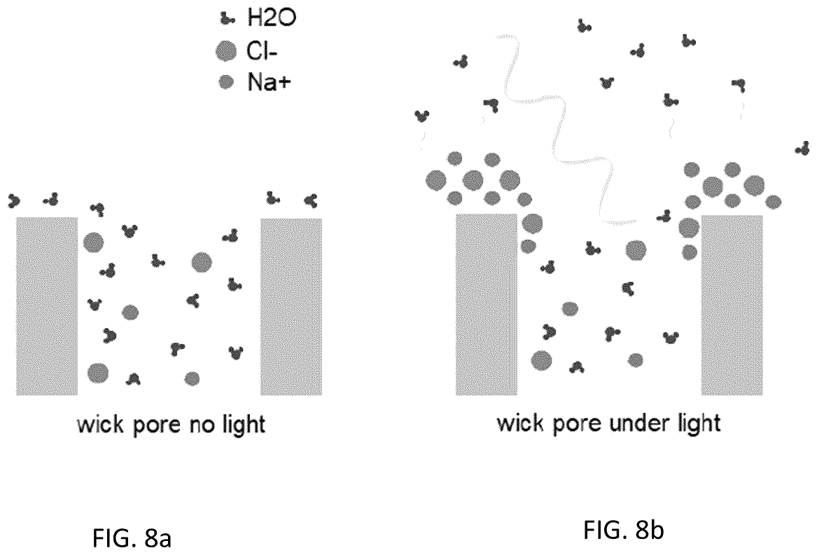

Initial nucleation of salt crystals depends on the localized surface concentration of sodium and chloride ions, which is controlled by the location of evaporation fluxes at the surface. It was expected that greater evaporation fluxes to occur near the periphery of the wick, due to the higher number of solid-liquid-vapor interfaces near the edges. This effect can be seen in FIG. 8, where the edges of the wicks have visually larger crystals of salt than those on the surface. Unfortunately, quantifying this effect can be difficult even with molecular dynamic simulations, as the very nature of porous materials are disordered tunnels at a micro- and lower scale.

Not only that, there are two separate types of disorders present in these porous materials: surface and internal disorders. Surface disorders determine the variations in evaporation rates across the surface of the wick while internal disorders determine the variations in sodium/chloride concentrations within the salt solutions being wicked up. These disorders are random, and consequently the locations for nucleation and subsequent crystallization are randomized as well.

The resulting salt formations after trials follow the expected patterns, where it appears to preferentially crystallize around edges and/or forming clusters on the face of the wick, presumably the initial nucleation points on the face. This indicates solid-liquid-air interface-based and also nucleation-location based crystallization. When evaporation happens rapidly in the beginning, salt starts nucleating closer to the bottom of the wick (the beginning of the waterfront); when it is slower, more of the wick becomes imbibed and thus more sporadic but spread-out nucleation occurs.

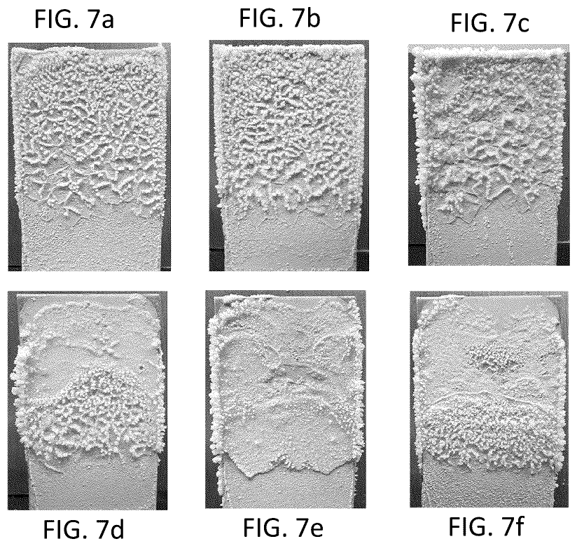

The crystallization patterns also show signs of salt creep, as salt crystals not only branch outward from the edges of the wick, particularly in FIG. 7 c), d), e), and f) which uncoincidentally have the higher evaporation rates. The salt growth in those particular trials also branched onto the sides of the wick (not visible in FIG. 7).

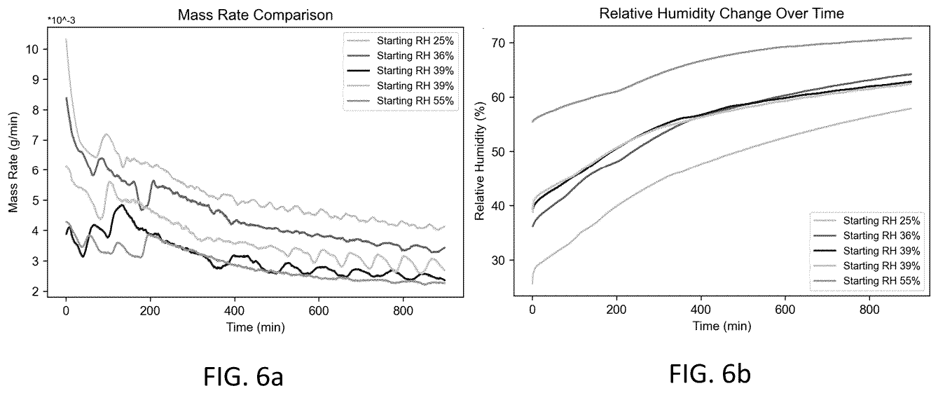

FIG. 6a-7f show that the evaporation of the wick slows but does not stop, even with full coverage of the wick face by salt crystallization over the 15 hour trial. The salt crystals instead appear to take over some parts of the capillary action from the Al—N, though at a much slower rate starting from 400 minutes into the trial. There is a distinct possibility that the slopes level out when salt covers the face of the wick, as salt crystals reflect much more light and thus diminishes the contribution of light. Still, this result indicates that the wick can be utilized for self-actuated salt-creep and thus salt removal from a reservoir.

Evaporation Rate Oscillations

Some of the experiments showed a pattern developing near the latter half of their run in which the evaporation rate would increase and decrease periodically in an oscillatory pattern, viewable in FIG. 7a. This phenomenon can be very readily seen in the runs with starting RH 39%. These oscillations in evaporation rate could stem from cycles of evaporation and crystallization, into dissolution, and back to evaporation. The decrease in evaporation rate stems from the blockage of pores from the interior formation of salt crystals coupled with a hindrance of light absorption from the exterior salt crystallization. The upswing after this decline comes from the salt gradient that develops during the process; the localized salt concentration in the pores and the surface are higher than at the reservoir due to evaporation and thus induces some water movement. The interior pores clogged by the salt crystals are re-hydrated and some water climbs up onto the exterior crystals, dissolving the interior salt crystals back into a solution while the exterior crystals remain in place but undergo salt creep. These cyclic processes then repeat through till the end experiment.

Both crystallization and dissolution are happening simultaneously, but whichever rate is higher determines the slope direction. Downward slopes are driven by evaporation leaving behind salt crystals that: if formed on the surface, start reflecting more light; if formed deeper in pores, impedes water movement. Upward slopes start when dissolution overtakes, reopening some pathways. Larger crystals that formed on the surface are capable of transferring water over their surface as well, so they begin growing and/or creeping.

Light and humidity affect the oscillations as well. Oscillations still occur in trials without light, but light seems to both enhance the amplitude and increase the length of the upward and downward slopes of the oscillations. Higher humidities meanwhile have dampened amplitudes. These experiments are nonlinear systems though, so initial conditions affect the process of the evaporation as well as the crystallization. Thus, precise reasons for the oscillations as well as any conditions that affect them need further study.

In accordance with an embodiment, microporous aluminum nitride is capable of evaporation of high salinity brines, for example, under 405 nm light, with evaporation rates between 1.57 and 3.13 kg m⁻² hr⁻¹ depending on the relative humidity of the surroundings. Higher relative humidity meant lower overall evaporation. The system does this non-thermally, but the actual effect that light has on the system will be a future study topic. The working theory is that it increases the free energy of the system in order to enhance evaporation. Oscillations also occur in the latter half of some of the experiments. They may be stemming from a cycle of evaporation, crystallization, dissolution and salt creep. This evaporation method acts as a nonlinear system, so initial conditions greatly affect the process. Precise actuators/catalysts require further study as well.

The wick can be utilized for salt creep and cleaning of high salinity brines. Brine generated from factories and other water-purification processes harms the environment; if instead the salt and water in brine were separated by crystallizing the salt and/or evaporating the liquid water, the solid by-products are easier and safer to dispose of.

In addition to that, Al—N in this form acts like a white surface with low visible-light-spectrum emissivity. Al—N is a radiative cooling material that emits in the infrared atmospheric window. This means that the wick can maintain average surface temperatures that are lower than its surroundings during the day, and also at night. This radiative cooling effect would enhance results when used outdoors and also mitigate environmental damages that arrives from thermal effects.

### Additional Experiments

A porous wick was fabricated with 10-micron aluminum nitride particles. Capillary action moves “packets” of salt water to the light source. The packing of the particles should not be close; it is important that they form capillaries, but not so small that they impede the movement of the water molecules. The evaporation was studied that influences the movement of water in the pores.

Light from a solar simulator can be collimated to a 1-cm-diameter area with 350-mW power (approximately 3 suns). The wick was placed in a reservoir and illuminated with light for 800 minutes. The mass change was monitored. The experiments were performed with 35000, 143000, and 300000 ppm saltwater solutions to simulate sea water, high-salinity brine, and runoff brine. Mass measurements were taken on micro-balance every minute. The effect of light illumination intensity and illumination areas, salinity, and wick properties, and illumination was studied as well as the effects associated with salt damage to the wick over 12 trials with each wick.

### Results

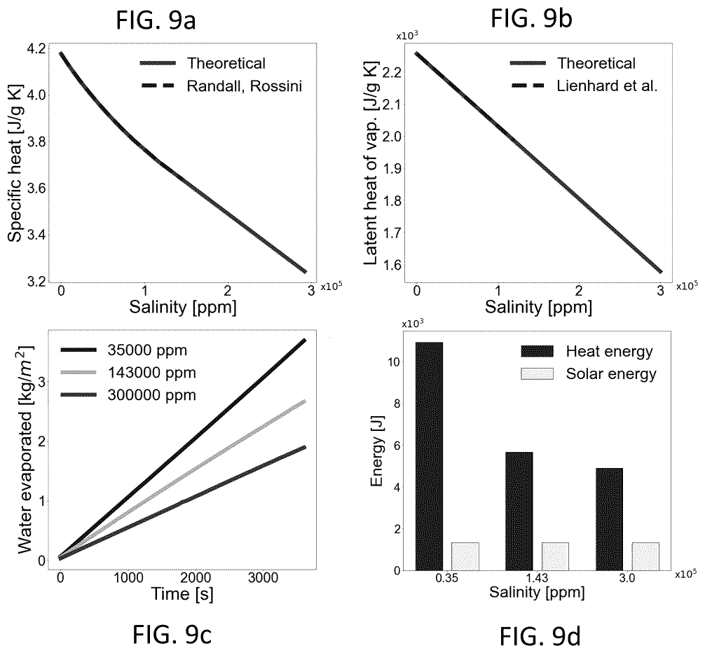

The solutions with lower salt concentration achieve higher evaporation rates. Higher salt concentrations raise the vapor pressure of the solution; as the salt con centration increases, it is harder for the water molecules to evaporate, which can be associated with boiling point elevation. At the same time, the specific heat and heat of vaporization decrease with higher salinities. With the effective illumination of 3 suns, the drop-cast solar wick reaches evaporation rates of 3.7 kg/m²/h, 2.7 kg/m²/h, and 1.9 kg/m²/h with 35000 ppm, 143000 ppm, and 300000 ppm salt solution, respectively. These rates represent the slopes of the mass per time curves in FIG. 9c. Significantly more water is evaporated than expected given the illuminated light power of 3 suns. For the disclosed system, the energy comparison between thermal boil and the solar desalination wick system was in the ranges 3 to 8 times greater as illustrated in FIG. 9d.

### FURTHER EXPERIMENT

In accordance with another embodiment, since experiments are often sensitive to air currents and changes in humidity, a self-referenced set-up with microbalances was used to perform the experiments as set forth below. In the subject experiment, a 405 nm LED with an output irradiance of 35 mWcm⁻² to 100 mWcm⁻² was used. A hygrometer was used to measure and control the ambient relative humidity, which was maintained between 30% to 35% prior to initiating experiments. All equipment was placed in an isolated, sealed acrylic box, which was covered in welding cloth to shield from ambient light. Light was focused onto a wick made from drop-cast aluminum nitride (Al—N) on an aluminum substrate. The capillary response of the wick is characterized. The wick was illuminated at normal incidence and placed in a 40-mL reservoir of brine (10 wt % NaCl to 30 wt % NaCl in deionized water). The mass was recorded continuously with a precision micro-balance. Simultaneously, an identical setup with a sample and without light is placed adjacent inside the same box with a glass shield placed between the two balances to prevent cross-interference from convection currents. Afterwards, the experiment was allowed to run 900 minutes and simple background evaporation with no light or salt was used as a reference to determine the effectiveness of the wick under varying intensities of light and salinity.

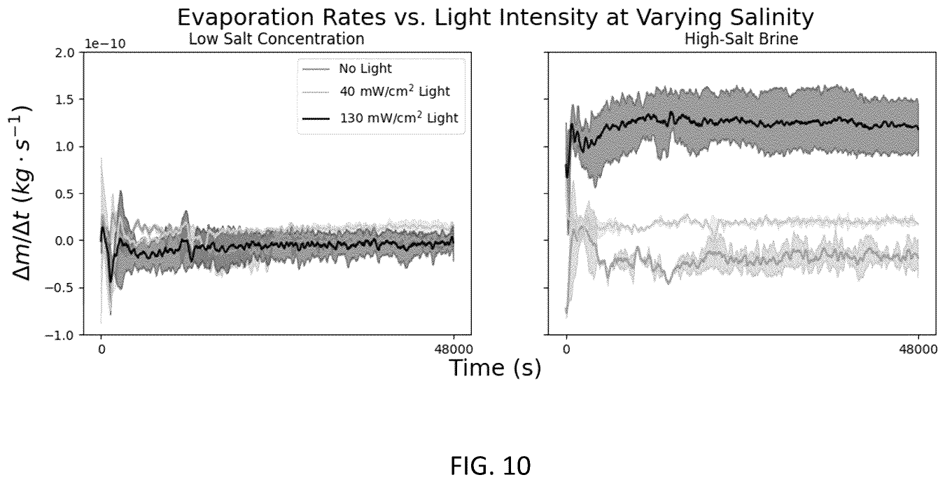

FIG. 10 illustrates evaporation rates versus light intensity at varying salinity. All data shown in an average of three experiments with error-bars shown as semi-transparent fill. The graph show experiments where an Al—N wick is illuminated with no light and with 40 mW/cm² and a 130 mW/cm² light sources. When the light is turned off, salinity plays a minimal role in evaporation rates, as evidenced by the relatively flat lines in each graph.

The detailed description above describes embodiments of a method and system for capillary flow in microporous aluminum nitride for non-thermal solar desalination. The invention is not limited, however, to the precise embodiments and variations described. Various changes, modifications and equivalents may occur to one skilled in the art without departing from the spirit and scope of the invention as defined in the accompanying claims. It is expressly intended that all such changes, modifications and equivalents which fall within the scope of the claims are embraced by the claims.

What is claimed is:

1. A microporous wick, the microporous wick comprising:
a plurality of bonded aluminum nitride particles.

2. The microporous wick according to claim 1, wherein the aluminum nitride particles are microparticles.

3. The microporous wick according to claim 1, wherein the aluminum nitride particles have a diameter of approximately 10 μm.

4. The microporous wick according to claim 1, wherein the plurality of bonded aluminum nitride particles forms a plurality of channels, the plurality of channels having approximately a same diameter as the plurality of aluminum nitride particles themselves.

5. The microporous wick according to claim 1, wherein the plurality of bonded aluminum nitride particles forms a plurality of capillaries.

6. A method for non-thermal solar desalination or debrining, the method comprising:
placing a capillary wick in a brine containing sodium chloride or other ions, the capillary wick comprising a plurality of bonded aluminum nitride microparticles; and
illuminating the capillary wick with a light source.

7. The method according to claim 6, further comprising:
illuminating the capillary wick with the light source having a wavelength of 190 nanometers to 750 nanometers.

8. The method according to claim 6, further comprising:
illuminating the capillary wick with the light source having a wavelength of 190-nanometers to 495 nanometers.

9. The method according to claim 6, further comprising:
Illuminating the capillary wick with the light source having a wavelength of 380 nanometers to 495 nanometers.

10. The method according to claim 6, further comprising:
illuminating the capillary wick with the light source having a wavelength of 450 nanometers to 495 nanometers.

11. The method according to claim 6, further comprising illuminating the capillary wick with the light source having a wavelength of wavelength of 380 nanometers to 750 nanometers at 35 mW·cm⁻² to 100 mW·cm⁻².

12. The method according to claim 6, wherein the brine is sea water.

13. The method according to claim 6, further comprising:
reducing a relative humidity of a surrounding of the capillary wick and the brine to increase evaporation rate.

14. The method according to claim 6, further comprising:
separating the sodium chloride from water in the brine by crystallizing the sodium chloride and evaporating the water as a liquid.

15. The method according to claim 6, further comprising:
obtaining a zero liquid discharge in the separation of the sodium chloride from the water in the brine and the evaporation of the water as a liquid.

16. The method according to claim 6, wherein the brine is from an industrial source.

17. The method according to claim 6, wherein the brine is a waste-water brine or industrial effluent.

18. The method according to claim 6, wherein the brine is a brine carrying valuable minerals to be harvested.

19. A method for evaporative cooling that leverages radiative cooling of aluminum nitride comprising:
blowing a source of air through a capillary wick to obtain cooling from evaporation outdoors, the capillary wick comprising a plurality of bonded aluminum nitride microparticles.
